(19) United States
(12) Patent Application Publication
(10) Pub. No.: US 2025/0225912 A1
(43) Pub. Date: Jul. 10, 2025

(54) ELECTRONIC DEVICE COMPRISING DISPLAY AND METHOD, FOR CHANGING MODES

(71) Applicant: SAMSUNG ELECTRONICS CO., LTD., Suwon-si, Gyeonggi-do (KR)

(72) Inventors: Jaesung LEE, Suwon-si, Gyeonggi-do (KR); Kyounghwan KWON, Suwon-si, Gyeonggi-do (KR); Jongkon BAE, Suwon-si, Gyeonggi-do (KR); Kwangtai KIM, Suwon-si, Gyeonggi-do (KR); Donghyun YEOM, Suwon-si, Gyeonggi-do (KR)

(21) Appl. No.: 19/094,308

(22) Filed: Mar. 28, 2025

Related U.S. Application Data
(63) Continuation of application No. PCT/KR2023/015151, filed on Sep. 27, 2023.

(30) Foreign Application Priority Data
Sep. 30, 2022 (KR) 10-2022-0125365
Jan. 4, 2023 (KR) 10-2023-0001471
Jan. 11, 2023 (KR) 10-2023-0004347
Jan. 11, 2023 (KR) 10-2023-0004350
Jan. 31, 2023 (KR) 10-2023-0013290
Feb. 8, 2023 (KR) 10-2023-0016868
Feb. 15, 2023 (KR) 10-2023-0020328
Feb. 28, 2023 (KR) 10-2023-0026723
Mar. 17, 2023 (KR) 10-2023-0035417
Mar. 20, 2023 (KR) 10-2023-0036185
Sep. 25, 2023 (WO) PCT/KR2023/014711
Sep. 26, 2023 (WO) PCT/KR2023/014939
Sep. 26, 2023 (WO) PCT/KR2023/014940

(51) Int. Cl. G09G 3/20

(52) U.S. Cl. CPC G09G 3/2096; G09G 2320/0247; G09G 2320/0257; G09G 2340/0435; G09G 2370/10

(57) ABSTRACT

An electronic device may include a processor. The electronic device may include a display comprising a display panel and a display driving circuit comprising a graphic random-access memory (GRAM). The electronic device may include an interface linking the processor and the display driving circuit. The display driving circuit may be configured to obtain a control command from the processor, indicating a change from a second mode, in which image transmission from the processor to the display driving circuit is executed on the basis of a timing identified by the processor, to a first mode, in which image transmission is executed on the basis of a timing identified by the display driving circuit. The display driving circuit may be configured to: store in the GRAM an image received from the processor via the interface on the basis of the image transmission based on the second mode; and display the image on the display panel. The display driving circuit may be configured to change from the second mode to the first mode, in response to storing the image, on the basis of the control command.

### CROSS-REFERENCE TO RELATED APPLICATIONS

This application is a continuation application of International Application No. PCT/KR2023/015151 designating the United States, filed on Sep. 27, 2023, in the Korean Intellectual Property Receiving Office and claiming priority to Korean Patent Application No. 10-2022-0125365 filed on Sep. 30, 2022 (8BBB); Korean Patent Application No. 10-2023-0001471 filed on Jan. 4, 2023 (EF92); Korean Patent Application No. 10-2023-0004347 filed on Jan. 11, 2023 (D045); Korean Patent Application No. 10-2023-0004350 filed on Jan. 11, 2023 (72FD); Korean Patent Application No. 10-2023-0013290 filed on Jan. 31, 2023 (169D); Korean Patent Application No. 10-2023-0016868 filed on Feb. 8, 2023 (2B07); Korean Patent Application No. 10-2023-0020328 filed on Feb. 15, 2023 (E3A5); Korean Patent Application No. 10-2023-0026723 filed on Feb. 28, 2023 (5BC5); Korean Patent Application No. 10-2023-0035417 filed on Mar. 17, 2023 (BCE8); Korean Patent Application No. 10-2023-0036185 filed on Mar. 20, 2023 (E80D); PCT International Application No. PCT/KR2023/014711 filed on Sep. 25, 2023; PCT International Application No. PCT/KR2023/014939 filed on Sep. 26, 2023; and PCT International Application No. PCT/KR2023/014940 filed on Sep. 26, 2023; the disclosures of which are all hereby incorporated by reference herein in their entireties.

### BACKGROUND

### Technical Field

Certain example embodiments may relate to an electronic device including a display for changing modes.

### Background Art

An electronic device may include a display panel. For example, the electronic device may include display driver circuitry operably coupled to the display panel. For example, the display driver circuitry may display, on the display panel, an image obtained from a processor of the electronic device.

The above-described information may be provided as a related art for the purpose of helping to understand the present disclosure. No claim or determination is raised as to whether any of the above-described information may be applied as a prior art related to the present disclosure.

### SUMMARY

An electronic device is provided. The electronic device may comprise at least one processor comprising processing circuitry. The electronic device may comprise a display including a display panel and display driver circuitry that includes a graphic random access memory (GRAM). The electronic device may comprise an interface, comprising interface circuitry, connecting the processor(s) to the display driver circuitry. The display driver circuitry may be configured to obtain, from the processor(s), a control command indicating to change a second mode executing an image transmission from the processor to the display driver circuitry based on a timing identified by the processor(s) to a first mode executing the image transmission based on a timing identified by the display driver circuitry. The display driver circuitry may be configured to store an image received via the interface from the processor(s) in accordance with the image transmission executed based on the second mode, in the GRAM, and display, on the display panel, the image received via the interface from the processor in accordance with the image transmission executed based on the second mode. The display driver circuitry may be configured to, in response to storing the image, change, based on the control command, the second mode to the first mode.

An electronic device is provided. The electronic device may comprise at least one processor comprising processing circuitry. The electronic device may comprise a display including a display panel and display driver circuitry that includes a graphic random access memory (GRAM). The electronic device may comprise an interface connecting the processor(s) to the display driver circuitry. The display driver circuitry may be configured to obtain, from the processor(s), a control command indicating to change a first mode executing an image transmission based on a timing identified by the display driver circuitry to a second mode executing the image transmission from the processor(s) to the display driver circuitry based on a timing identified by the processor. The display driver circuitry may be configured to, in response to the control command, provide, to the processor(s), a signal indicating a request of the image transmission executed based on the second mode. The processor(s) may be configured to, within a reference time being from a timing of obtaining the signal from the display driver circuitry, execute periodic transmissions of a pulse signal to the display driver circuitry to synchronize at least one time interval in the processor(s) used for a displaying on the display panel with at least one time interval in the display driver circuitry used for the displaying on the display panel. The processor(s) may be configured to, in response to the number of the periodic transmissions reaching a reference number, transmit, via the interface, to the display driver circuitry, an image in accordance with the image transmission executed based on the second mode.

### DESCRIPTION OF THE DRAWINGS

FIG. 1 is a simplified block diagram illustrating an exemplary electronic device.

FIG. 2 illustrates an exemplary method of changing a second mode to a first mode.

FIG. 3 illustrates an example of changing from a second mode to a first mode and an example of changing from the first mode to the second mode.

FIG. 4 illustrates an example of changing a signal provided to a processor from display driver circuitry from a first signal to a second signal or from the second signal to the first signal.

FIG. 5 illustrates an exemplary method of refraining from processing an image in accordance with an image transmission executed based on a second mode after changing the second mode to a first mode.

FIG. 6 illustrates an example of refraining from processing an image in accordance with an image transmission executed based on a second mode after changing the second mode to a first mode.

FIG. 7 illustrates an exemplary method of changing a first mode to a second mode after changing the second mode to the first mode.

FIG. 8 illustrates an example of changing a first mode to a second mode.

FIG. 9 illustrates an exemplary method of deferring changing from a first mode to a second mode.

FIGS. 10 and 11 illustrate an example of deferring changing a first mode to a second mode.

FIG. 12 illustrates an exemplary method of changing a first mode to a second mode.

FIG. 13 illustrates an exemplary method of changing a second mode to a first mode after changing the first mode to the second mode.

FIG. 14 is a block diagram of an electronic device in a network environment according to various example embodiments.

FIG. 15 is a block diagram of a display module according to various example embodiments.

### DETAILED DESCRIPTION

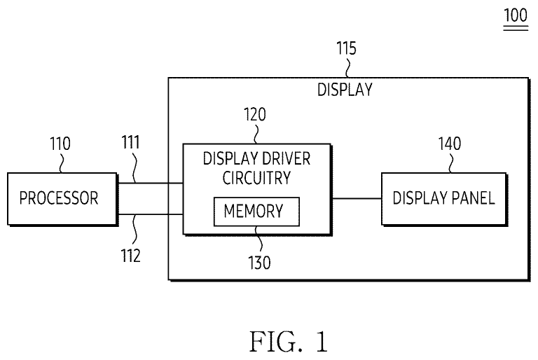

FIG. 1 is a simplified block diagram illustrating an exemplary electronic device.

Referring to FIG. 1, an electronic device 100 may include a processor 110 and a display 115.

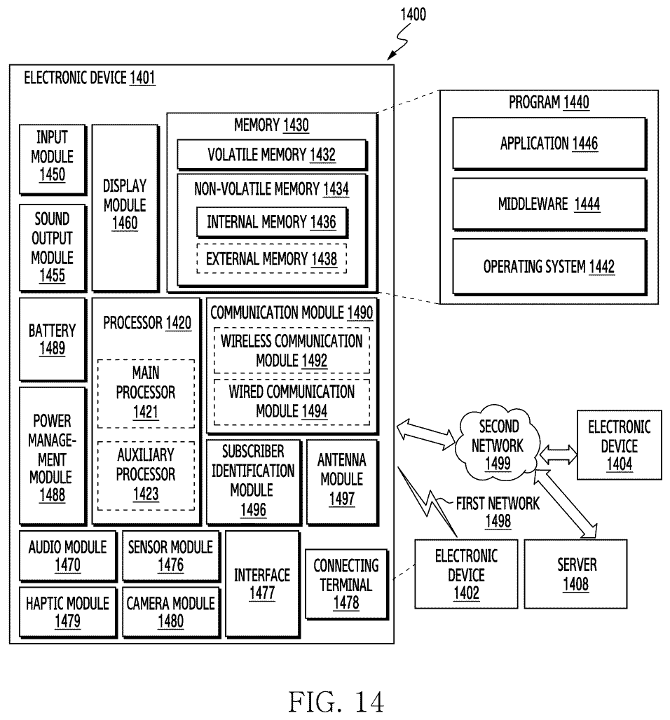

The processor 110 may include at least a portion of a processor 1420 of FIG. 14. The processor 110 may be operably coupled with display driver circuitry 120 (or the display 115). The processor 110 being operably coupled with the display driver circuitry 120 may indicate that the processor 110 is directly or indirectly connected to the display driver circuitry 120. For example, the processor 110 being operably coupled with the display driver circuitry 120 may indicate that the processor 110 is connected to the display driver circuitry 120 via a first interface 111. The first interface 111 may be used to an image transmission from the processor 110 to the display driver circuitry 120. For example, the processor 110 being operably coupled with the display driver circuitry 120 may indicate that the processor 110 is connected to the display driver circuitry 120 via a second interface 112. The second interface 112 separated from the first interface 111 may be used to provide a signal from the display driver circuitry 120 to the processor 110. The signal may include a first signal, a second signal, and/or a third signal to be illustrated below.

The second interface 112 may be further used for periodic transmissions of a pulse signal from the processor 110 to the display driver circuitry 120. However, it is not limited thereto. The pulse signal may be periodically transmitted from the processor 110 to the display driver circuitry 120 via a third interface (not illustrated in FIG. 1) separated from the second interface 112. As a non-limiting example, the pulse signal may be referred to as an external synchronization signal (Esync).

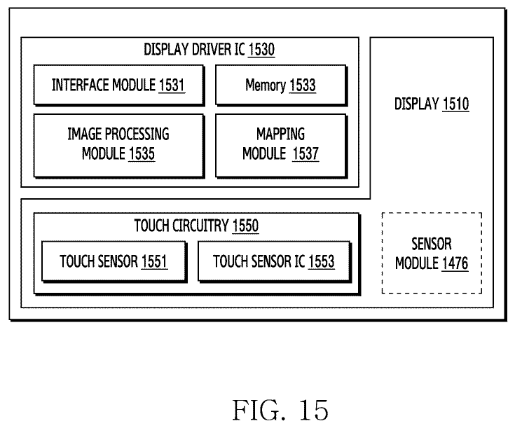

The display 115 may include at least a portion of a display module 1460 of FIGS. 14 and 15. The display 115 may include display driver circuitry 120 and a display panel 140.

The display driver circuitry 120 may include at least a portion of a DDI 1530 of FIG. 15. The display driver circuitry 120 may include memory 130. The memory 130 may include at least a portion of memory 1533. The memory 130 may be referred to as a graphic random access memory (GRAM) or a frame buffer memory.

The display panel 140 may include at least a portion of a display 1510 of FIG. 15.

Each of the processor 110, the first interface 111, and the display driver circuitry 120 may be configured for a first mode or a second mode.

The first mode may indicate a mode of executing an image transmission from the processor 110 to the display driver circuitry 120 via the first interface 111 based on a timing identified by the display driver circuitry 120 (or timing for the display driver circuitry 120). For example, the first mode may be a command mode of a mobile industry processor interface (MIPI) display serial interface (DSI). As a non-limiting example, it may be mandatory to store, in the memory 130, an image received from the processor 110 via the first interface 111 in accordance with the image transmission executed based on the first mode. As a non-limiting example, a throughput of the image transmission executed based on the first mode may be greater than a throughput of the image transmission executed based on the second mode. For example, the image transmission executed based on the first mode may be a data burst transmission, unlike the image transmission executed based on the second mode. As a non-limiting example, the first mode may be a mode for always on display (AOD). As a non-limiting example, a 2ch command may be provided to the display driver circuitry 120 to indicate the image transmission executed for the first mode before the image transmission executed for the first mode.

The second mode may indicate a mode executing the image transmission based on a timing identified by the processor 110 (or timing for the processor 110). For example, the second mode may be a video mode of the MIPI DSI or a mode similar to the video mode. As a non-limiting example, the second mode may be partially different from the video mode. As a non-limiting example, it may be optional to store, in the memory 130, an image received from the processor 110 via the first interface 111 in accordance with the image transmission executed based on the second mode. For example, storing, in the memory 130, the image in the second mode may be executed to reduce occurrence of an afterimage on the display panel 140 or flickering on the display panel 140. As a non-limiting example, a throughput of the image transmission executed based on the second mode may be smaller than a throughput of the image transmission executed based on the first mode. As a non-limiting example, a vertical sync start (VSS) packet may be provided to the display driver circuitry 120 to indicate the image transmission executed for the second mode before the image transmission executed for the second mode.

The first mode may be changed to the second mode, and the second mode may be changed to the first mode. For example, as the changing from the first mode to the second mode and/or the changing from the second mode to the first mode becomes more transparent to the user, a quality of a service provided through the display 115 may be enhanced.

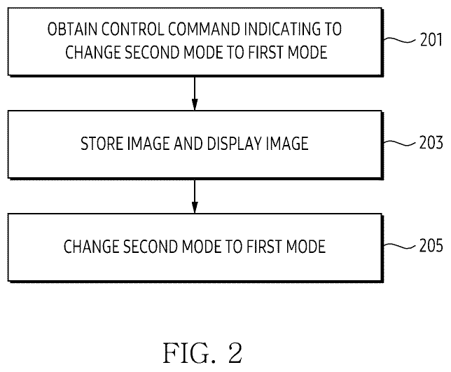

The following descriptions may be related to operations for seamlessly changing (or transitioning) from the first mode to the second mode and/or seamlessly changing (or transitioning) from the second mode to the first mode. The operations will be exemplified in the descriptions of FIGS. 2 to 13.

FIG. 2 illustrates an exemplary method of changing a second mode to a first mode.

Referring to FIG. 2, in operation 201, the display driver circuitry 120 may obtain, from the processor 110, a control command (e.g., set_DSI_mode) indicating to change the second mode to the first mode. For example, the display driver circuitry 120 may obtain, from the processor 110, another control command indicating a refresh rate for the first mode, together with the control command. For another example, the display driver circuitry 120 may identify, based at least in part on the control command, the refresh rate for the first mode that is pre-stored for (or within) the display driver circuitry 120.

As a non-limiting example, the control command and/or the other control command may be provided from the processor 110 before a last image transmission to be executed based on the second mode. For example, the processor 110 may provide one or more images to the display driver circuitry 120 in accordance with one or more image transmissions respectively executed based on the second mode, after providing the control command and the other control command to the display driver circuitry 120. For example, the number of the one or more images may be shared in advance with the display driver circuitry 120. For example, the number of the one or more images may be predefined. However, it is not limited thereto.

In operation 203, the display driver circuitry 120 may store, in the memory 130, an image received from the processor 110 via the first interface 111 in accordance with the image transmission executed based on the second mode, and display, on the display panel 140, the image received from the processor 110 via the first interface 111 in accordance with the image transmission executed based on the second mode.

For example, when the number of the one or more images is 1, the image may be an initial image to be displayed in the first mode. However, it is not limited thereto.

For example, storing the image and displaying the image may be executed by the display driver circuitry 120 operating for the second mode. For example, for the seamlessly changing from the second mode to the first mode, the display driver circuitry 120 may operate for the second mode in operation 203 after the control command is obtained. For example, since the display driver circuitry 120 operates for the second mode in operation 203, storing the image in the memory 130 and displaying the image on the display panel 140 may be executed in parallel. For example, a first time interval between a timing to initiate storing the image in operation 203 and a timing to initiate displaying the image in operation 203 may be shorter than a second time interval between a timing to initiate storing an image in the memory 130 using the display driver circuitry 120 operating for the first mode and a timing to initiate displaying an image using the display driver circuitry 120 operating for the first mode. For example, displaying of an image on the display panel 140, executed within a time interval of storing the image in the second mode, is executed by scanning the image received from the processor 110 and displaying of an image on the display panel 140, executed within a time interval of storing the image in the first mode, is executed by scanning the image in the memory 130, so the first time interval may be shorter than the second time interval.

For example, the display driver circuitry 120 may display, on the display panel 140, the image received from the processor 110 via the first interface 111, based on a refresh rate for the second mode.

For example, the processor 110 may execute, in the second mode, periodic transmissions of a pulse signal to the display driver circuitry 120, in order to synchronize at least one time interval (or time period) in the processor 110 used for displaying on the display panel 140 (e.g., a period of a horizontal synchronization signal for the processor 110, a period of a vertical synchronization signals for the processor 110, and/or a period of a light emitting synchronization signal for the processor 110) with at least one time interval in the display driver circuitry 120 used for the displaying on the display panel 140 (e.g., a period of a horizontal synchronization signal for the display driver circuitry 120, a period of a vertical synchronization signal for the display driver circuitry 120, and/or a period of a light emitting synchronization signal for the display driver circuitry 120). For example, the processor 110 may cease the periodic transmissions after providing the control command to the display driver circuitry 120. For example, the processor 110 may cease the periodic transmissions of the pulse signal before changing a mode of the display driver circuitry from the second mode to the first mode. For example, the processor 110 may cease the periodic transmissions based on transmitting the image to the display driver circuitry 120 in accordance with the image transmission executed based on the second mode for the displaying of the image in operation 203. For example, the periodic transmissions may be ceased after being executed for the displaying of the image in operation 203. However, it is not limited thereto.

In operation 205, in response to storing the image, the display driver circuitry 120 may change the second mode to the first mode based on the control command. Changing the second mode to the first mode may indicate that the display driver circuitry 120 operates for the first mode within a time interval following a time interval (e.g., a time interval of the vertical synchronization signal for the display driver circuitry 120) for storing the image and for displaying the image in operation 203.

For example, in response to the changing from the second mode to the first mode, the display driver circuitry 120 may display again, on the display panel 140, the image, by scanning the image in the memory 130 based on a refresh rate for the first mode.

For example, in response to the changing from the second mode to the first mode, the display driver circuitry 120 may provide, to the processor 110, the first signal indicating a timing of the image transmission to be executed based on the first mode, based on the refresh rate for the first mode. The first signal may be a tearing effect (TE) signal. The first signal may be different from the second signal provided to the processor 110 in the second mode. For example, unlike the second signal indicating whether enabling or disabling the image transmission to be executed based on the second mode, the first signal may indicate a timing of the image transmission to be executed based on the first mode. As a non-limiting example, the second signal may be referred to as a refresh window (RW) signal (or RW). For example, unlike the image transmission executed based on the second mode, since the image transmission executed based on the first mode is executed in accordance with a timing identified by the display driver circuitry 120, the first signal may be different from the second signal.

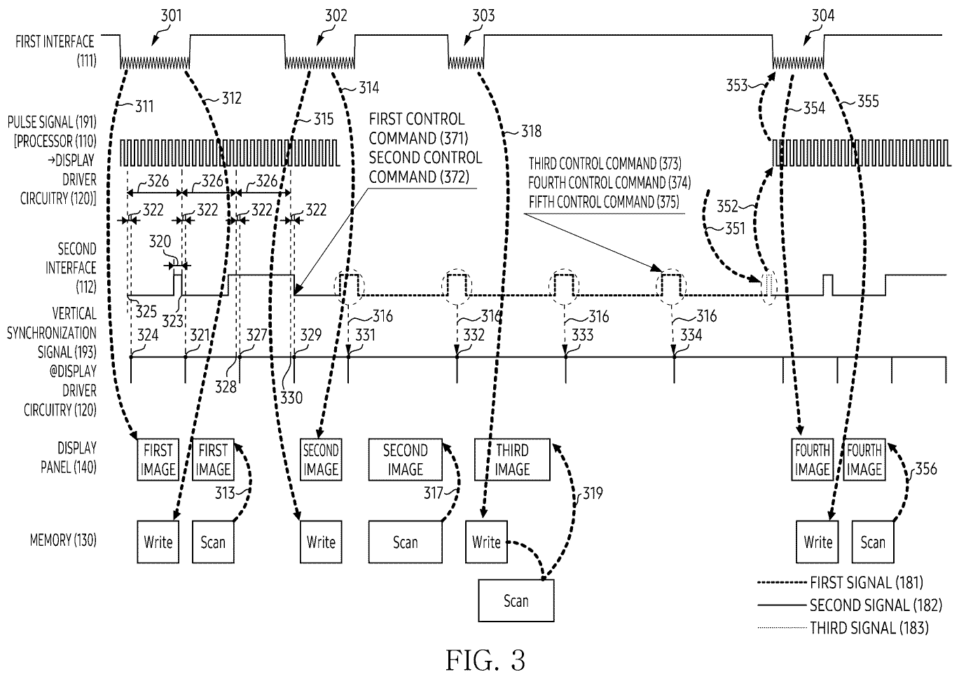

Operations 201 to 205 may be further exemplified in the description of FIG. 3.

FIG. 3 illustrates an example of changing from a second mode to a first mode and an example of changing from the first mode to the second mode.

Referring to FIG. 3, the processor 110 may transmit a first image to the display driver circuitry 120 via the first interface 111 in accordance with the image transmission executed based on the second mode, as in a state 301. For example, the display driver circuitry 120 may display the first image on the display panel 140, as indicated by arrows 311. For example, the display driver circuitry 120 may store the first image in the memory 130 (or write the first image to the memory 130), as indicated by arrows 312. For example, displaying the first image and storing the first image may be executed based on a refresh rate for the second mode. For example, displaying the first image and storing the first image may be executed based on a vertical synchronization signal 193 for the display driver circuitry 120 synchronized with a vertical synchronization signal for the processor 110 in accordance with a pulse signal 191.

For example, since the pulse signal 191 is transmitted at every period of a horizontal synchronization signal for the processor 110, the vertical synchronization signal for the display driver circuitry 120 may be synchronized with the vertical synchronization signal for the processor 110. For example, at a timing of the horizontal synchronization signal for the processor 110 overlapping a timing of the vertical synchronization signal for the processor 110, since the pulse signal 191 transmitted at every period has a waveform (or pulse width) different from a waveform (or pulse width) of the pulse signal at a timing of the horizontal synchronization signal for the processor 110, which does not overlap with a timing of the vertical synchronization signal for the processor 110, the vertical synchronization signal for the display driver circuitry 120 may be synchronized with the vertical synchronization signal for the processor 110. Although not illustrated in FIG. 3, since the pulse signal 191 has a waveform different from a waveform of the pulse signal at a timing of a light emitting synchronization signal for the processor 110, which does not overlap a timing of the horizontal synchronization signal for the processor 110, at a timing of the light emitting synchronization signal for the processor 110 overlapping a timing of the horizontal synchronization signal for the processor 110, the vertical synchronization signal for the display driver circuitry 120 may be synchronized with the vertical synchronization signal for the processor 110.

For example, the display driver circuitry 120 may provide, to the processor 110 via the second interface 112, a second signal 182, in the second mode. For example, the second signal 182 may indicate whether enabling the image transmission to be executed based on the second mode.

For example, the display driver circuitry 120 may change a state of the second signal 182 from a second state to a first state, in response to completion of scanning for displaying the first image. The display driver circuitry 120 may change the state of the second signal 182 from the first state to the second state at a timing 323 before a reference time 322 from a timing 321 capable of executing the image transmission, as indicated by arrows 313, for scanning of the first image in the memory 130 executed to display again the first image again on the display panel 140. For example, the changing from the first state to the second state at a timing 323 may be executed to reduce executing the image transmission based on the second mode from at least one start timing of a light emitting synchronization signal for the processor 110, which is between a timing 321 and a timing 327.

For example, the processor 110 may identify whether the image transmission to be executed based on the second mode is enabled at a timing 321, based on a state of the second signal 182 within a time interval 326 between a timing 323 and a timing 325 before a reference time 322 from a timing 324 capable of executing the image transmission based on the second mode. For example, the processor 110 may identify that the image transmission from a timing 321 executed based on the second mode is enabled based on identifying the second signal 182 in the first state for a time 320 within the time interval 326. For example, unlike the illustration in FIG. 3, the processor 110 may transmit, to the display driver circuitry 120, via the first interface 111, an image in accordance with the image transmission executed based on the second mode at a timing 321. When the image is transmitted from the processor 110 to the display driver circuitry 120 via the first interface 111 in accordance with the image transmission at a timing 321 executed based on the second mode, unlike the illustration of FIG. 3, the display driver circuitry 120 may cancel the scanning indicated by arrows 313 and display the image on the display panel 140.

For example, the display driver circuitry 120 may display again the first image on the display panel 140, by executing scanning of the first image in the memory 130 indicated by arrows 313, based on a timing 321.

For example, the display driver circuitry 120 may change the state of the second signal 182 from the second state to the first state, in response to completion of the scanning of the first image in the memory 130. For example, in a time interval between a timing 327 and a timing 329, since scanning of an image by the display driver circuitry 120 is not present, the state of the second signal 182 may be maintained in the first state.

Meanwhile, since the second signal 182 has a time being in the first state within a time interval 326 between a timing 323 and a timing 328, the image transmission from a timing 327 executed based on the second mode may be enabled. The timing 328 may indicate a timing before the reference time 322 from the timing 327.

For example, the processor 110 may identify whether the image transmission from a timing 329 executed based on the second mode is enabled based on whether the second signal 182 in the first state is identified within a time interval 326 between a timing 328 and a timing 330. The timing 330 may indicate a timing before the reference time 322 from the timing 329. For example, the processor 110 may identify that the image transmission from a timing 392 executed based on the second mode is enabled, based on identifying the second signal 182 in the first state within a time interval 326 between a timing 328 and a timing 330. Based on the identification, the processor 110 may transmit, to the display driver circuitry 120, via the first interface 111, a second image, in accordance with the image transmission executed based on the second mode, as in the state 302. For example, the second image may be an initial image to be displayed in the first mode. As a non-limiting example, the processor 110 may provide, the display driver circuitry 120 with a first control command 371, which is the control command in the description of FIG. 2, and/or a second control command 372, which is the other control command in the description of FIG. 2. For example, the first control command 371 and/or the second control command 372 may be provided within a front porch (or front porch interval) of a vertical synchronization signal (e.g., the vertical synchronization signal 193). However, it is not limited thereto.

For example, the display driver circuitry 120 may display, on display panel 140, the second image, as indicated by arrows 314. For example, the display driver circuitry 120 may store, in the memory 130, the second image, as indicated by arrows 315. For example, the display driver circuitry 120 may store the second image based on the first control command 371 and/or the second control command 372. For example, since the display driver circuitry 120 identifies the second image as an initial image for the first mode based on the first control command 371 and/or the second control command 372, the display driver circuitry 120 may store the second image.

For example, displaying the second image and storing the second image may be executed based on a refresh rate for the second mode. For example, displaying the second image and storing the second image may be executed based on a vertical synchronization signal 193 for the display driver circuitry 120 synchronized with the vertical synchronization signal for the processor 110 in accordance with a pulse signal 191.

For example, the periodic transmissions of the pulse signals 191 may be ceased after being used for displaying the second image. For example, the processor 110 may cease the periodic transmissions based on transmitting the second image to the display driver circuitry 120. However, it is not limited thereto.

For example, the display driver circuitry 120 may change the second mode to the first mode, in response to storing the second image (or displaying the second image).

For example, the display driver circuitry 120 may change, based on the first control command 371 and/or the second control command 372, a signal provided to the processor 110 via a second interface 112 from the second signal 182 to the first signal 181 indicating a timing of the image transmission to be executed based on the first mode. For example, the display driver circuitry 120 may provide the first signal 181 to the processor 110 via the second interface 112, based on the refresh rate for the first mode indicated by the second control command 372.

As a non-limiting example, the refresh rate for the first mode may be a multiple or a divisor of the refresh rate for the second mode. For example, a period of a vertical synchronization signal provided for the first mode may be a multiple or a divisor of a period of a vertical synchronization signal provided for the second mode. For example, a period of a horizontal synchronization signal provided for the first mode may be a multiple or a divisor of a period of a horizontal synchronization signal provided for the second mode. For example, a period of a light emitting synchronization signal (indicating a light emitting interval) provided for the first mode may be a multiple or a divisor of a light emitting synchronization signal provided for the second mode. For example, when the refresh rate for the second mode is 120 hertz (Hz), the refresh rate for the first mode may be 60 (Hz), 48 (Hz), 30 (Hz), or 24 (Hz). For example, when the refresh rate for the second mode is 60 (Hz), the refresh rate for the first mode may be 30 (Hz), 15 (Hz), or 10 (Hz).

For example, the display driver circuitry 120 may provide, to the processor 110, the first signal 181 for indicating a timing 331, a timing 332, a timing 333, and a timing 334, which are timing of the image transmission capable of being executed in accordance with the refresh rate for the first mode, as indicated by arrows 316.

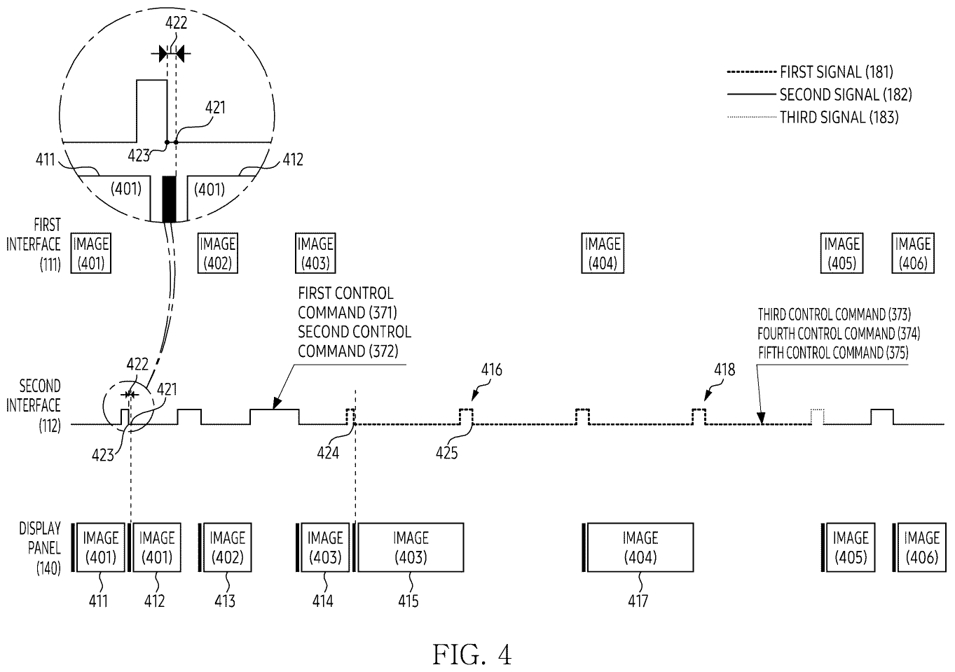

Changing a signal, which is provided to the processor 110 via the second interface 112 based on the first control command 371 and/or the second control command 372, from the second signal 182 to the first signal 181 may be further exemplified in the description of FIG. 4.

FIG. 4 illustrates an example of changing a signal provided to a processor from display driver circuitry from a first signal to a second signal or from the second signal to the first signal.

Referring to FIG. 4, the processor 110 may transmit, via the first interface 111, to the display driver circuitry 120, an image 401, based on a second signal 182 in the first state. For example, the transmission of the image 401 may be executed based on the second mode. The display driver circuitry 120 may store, in the memory 130, the image 401 and execute, on the display panel 140, first displaying 411 of the image 401. For example, the display driver circuitry 120 may maintain the state of the second signal 182 in the second state, during scanning of the image 401 for the first displaying 411 of the image 401.

For example, the display driver circuitry 120 may change a state of the second signal 182 for the second mode from the second state to the first state, in response to completion of scanning of the image 401 for the first displaying 411 of the image 401. For example, the display driver circuitry 120 may change the state of the second signal 182 from the first state to the second state at a timing 423 before a reference time 422 (e.g., the reference time 322) from a timing 421 capable of transmitting the image, for second displaying 412 of the image 401. For example, the display driver circuitry 120 may execute the second displaying 412 of the image 401 in accordance with the scanning of the image 401 in the memory 130 executed based on the timing 421. For example, the display driver circuitry 120 may maintain the state of the second signal 182 in the second state during scanning of the image 401 for the second displaying 412 of the image 401.

For example, the display driver circuitry 120 may change the state of the second signal 182 from the second state to the first state, in response to completion of the scanning of the image 401 for the second displaying 412 of the image 401. For example, the display driver circuitry 120 may identify an image 402 received from the processor 110 via the first interface 111, based on the second mode while the second signal 182 is within the first state. For example, the display driver circuitry 120 may change the state of the second signal 182 from the first state to the second state, in response to the image 402. For example, the display driver circuitry 120 may maintain the state of the second signal 182 in the second state during scanning of the image 402 for displaying 413 of the image 402 on the display panel 140.

For example, the display driver circuitry 120 may change the state of the second signal 182 from the second state to the first state, in response to completion of the scanning of the image 402 for the displaying 413 of the image 402. For example, the display driver circuitry 120 may obtain the first control command 371 and/or the second control command 372 from the processor 110 while the second signal 182 is within the first state.

For example, the display driver circuitry 120 may identify an image 403 received from the processor 110 via the first interface 111 based on the second mode while the second signal 182 is within the first state. The image 403 may be an image to be initially displayed in the first mode changed from the second mode. For example, the display driver circuitry 120 may change the state of the second signal 182 from the first state to the second state, in response to the image 403. For example, the display driver circuitry 120 may store, in the memory 130, the image 403. For example, the display driver circuitry 120 may maintain the state of the second signal 182 in the second state during scanning of the image 403 for the first displaying 414 of the image 403 on the display panel 140.

For example, the display driver circuitry 120 may refrain from changing the state of the second signal 182 from the second state to the first state in response to completion of the scanning of the image 403 for the first displaying 414 of the image 403, based on the first control command 371 and/or the second control command 372. For example, the display driver circuitry 120 may maintain the state of the second signal 182 in the second state after completion of the scanning of the image 403 for the first displaying 414 of the image 403 to provide the first signal 181 to the processor 110 via the second interface 112 at a timing 424 capable of initially executing the image transmission in accordance with the first mode changed from the second mode.

For example, the display driver circuitry 120 may change the second mode to the first mode in response to storing the image 403 and/or the first displaying 414 of the image 403, based on the first control command 371 and/or the second control command 372. For example, the display driver circuitry 120 may provide, to the processor 110, the first signal 181 changed from the second signal 182 to indicate the timing 424, based on the first mode changed from the second mode.

For example, the display driver circuitry 120 may execute second displaying 415 of the image 403 by scanning the image 403 in the memory 130 based on the timing 424. For example, unlike the first displaying 414 of the image 403, the second displaying 415 of the image 403 may be executed based on the refresh rate for the first mode.

For example, the display driver circuitry 120 may provide the first signal 181 to the processor 110 based on the refresh rate for the first mode, as indicated by a state 416. For example, the display driver circuitry 120 may provide the first signal 181 to the processor 110 to indicate a timing 425 in accordance with the refresh rate for the first mode. For example, the processor 110 may transmit, to the display driver circuitry 120, via the first interface 111, an image 404, in response to the first signal 181 for the first mode.

For example, the display driver circuitry 120 may store the image 404 in the memory 130, and execute displaying 417 of the image 404 on the display panel 140 by scanning the image 404 in the memory 130.

As described above, the display driver circuitry 120 may change the second signal 182 to the first signal 181, based on the first control command 371 and/or the second control command 372. For example, the display driver circuitry 120 may provide seamlessly changing from the second mode to the first mode by changing the second signal 182 to the first signal 181.

Referring back to FIG. 3, the display driver circuitry 120 may display again the second image on the display panel 140, by executing scanning of the second image in the memory 130 indicated by arrows 317, based on the timing 331. The displaying again of the second image may be executed based on the refresh rate for the first mode, which is different from the refresh rate for the second mode used for displaying the second image.

For example, the processor 110 may transmit, to the display driver circuitry 120 via the first interface 111, a third image, in accordance with the image transmission executed based on the first mode, as in the state 303, based on the first signal 181 provided from the display driver circuitry 120 for indicating the timing 332. For example, unlike the transmission of the first image and the transmission of the second image, the transmission of the third image may be a data burst transmission.

For example, the display driver circuitry 120 may store the third image in the memory 130, as indicated by arrows 318. For example, the display driver circuitry 120 may display, on the display panel 140, the third image, by scanning the third image in the memory 130, as indicated by arrows 319. The displaying of the third image may be executed based on the refresh rate for the first mode.

As described above, when the second mode is changed to the first mode, the electronic device 100 may execute the image transmission based on the second mode and scan the image stored in the memory 130, based on the first mode, in accordance with the image transmission. For example, the electronic device 100 may provide the seamlessly changing from the second mode to the first mode, through the image transmission executed based on the second mode and the scanning executed based on the first mode.

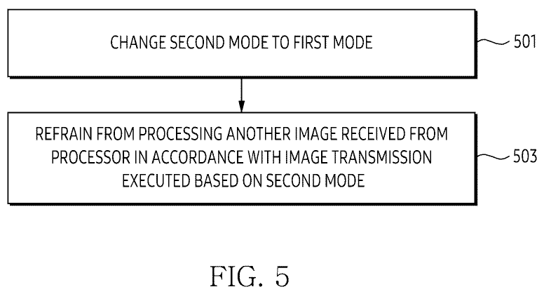

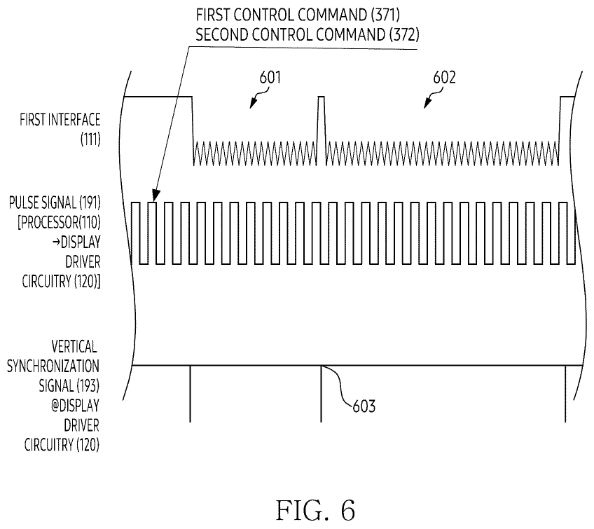

Referring back to FIG. 1, the display driver circuitry 120 may refrain from processing an image received from the processor 110 via the first interface 111 in accordance with the image transmission executed based on the second mode after changing to the first mode. The refraining from processing the image may be exemplified within the description of FIGS. 5 and 6.

FIG. 5 illustrates an exemplary method of refraining from processing an image in accordance with an image transmission executed based on a second mode after changing the second mode to a first mode.

Referring to FIG. 5, in operation 501, the display driver circuitry 120 may change the second mode to the first mode. Operation 501 may correspond to operation 205 of FIG. 2.

In operation 503, the display driver circuitry 120 may, in response to the changing from the second mode to the first mode, refrain from processing another image received from the processor via the interface (e.g., the first interface 111) in accordance with the image transmission executed based on the second mode in at least a portion of a time interval for displaying again the image on the display panel 140. For example, the displaying again the image may indicate displaying the image stored in the memory 130 in accordance with the second mode. For example, displaying again the image may be the displaying of the second image in accordance with scanning of the second image indicated by the arrows 317 of FIG. 3.

For example, the display driver circuitry 120 may refrain from processing the other image by ignoring the other image received in accordance with the second mode, after changing the second mode to the first mode. For example, the display driver circuitry 120 may maintain the first mode changed from the second mode. Refraining from processing the other image and maintaining the first mode may be exemplified within the description of FIG. 6.

FIG. 6 illustrates an example of refraining from processing an image in accordance with an image transmission executed based on a second mode after changing the second mode to a first mode.

Referring to FIG. 6, the processor 110 may transmit, via the first interface 111, to the display driver circuitry 120, the image (e.g., the second image of FIG. 3) in accordance with the image transmission executed based on the second mode, as in the state 601, after providing the first control command 371 and/or the second control command 372 to the display driver circuitry 120. For example, the display driver circuitry 120 may store the image in the memory 130 based on the first control command 371 and/or the second control command 372. For example, the display driver circuitry 120 may display, on the display panel 140, the image, based on the refresh rate for the second mode.

For example, the display driver circuitry 120 may change the second mode to the first mode based on a timing 603, in response to storing the image and/or displaying the image.

For example, the processor 110 may maintain the periodic transmissions of the pulse signal 191 even though the second mode has been changed to the first mode. For example, the processor 110 may transmit, to the display driver circuitry 120 via the first interface 111, the other image, in accordance with the timing 603 based on the second mode, as in a state 602, even though the second mode has been changed to the first mode. For example, the display driver circuitry 120 may, in response to identifying that the transmission of the other image is executed based on the second mode, refrain from processing the other image for displaying on the display panel 140, by ignoring the other image. Although not illustrated in FIG. 6, the display driver circuitry 120 may refrain from displaying the other image on the display panel 140 and display again the image (e.g., the second image of FIG. 3) on the display panel 140. For example, displaying again the image on the display panel 140 may be executed based on scanning the image stored in the memory 130.

As described above, the electronic device 100 may provide changing seamlessly from the second mode to the first mode by using the display driver circuitry 120 maintaining the first mode, unlike the processor 110 operating for the second mode, after the second mode is changed to the first mode.

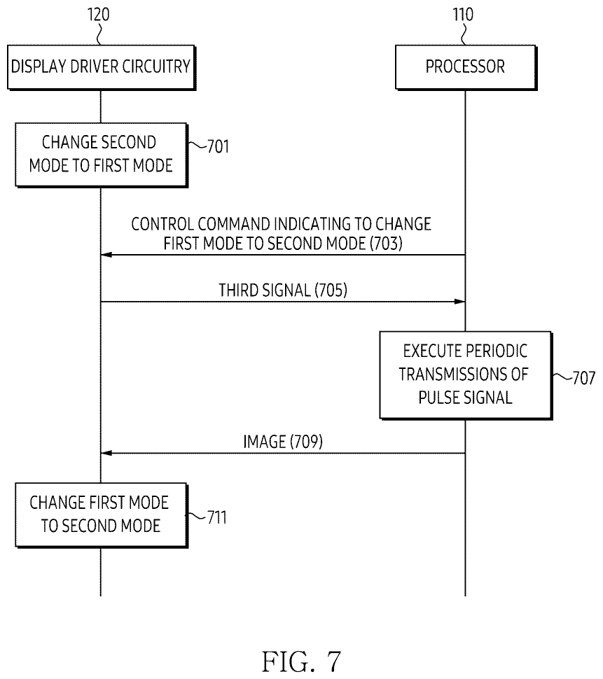

Referring back to FIG. 1, the first mode changed from the second mode may be restored to the second mode. Changing the first mode to the second mode after changing the second mode to the first mode may be exemplified within the description of FIG. 7.

FIG. 7 illustrates an exemplary method of changing a first mode to a second mode after changing the second mode to the first mode.

Referring to FIG. 7, in operation 701, the display driver circuitry 120 may change the second mode to the first mode. Operation 701 may correspond to operation 205 of FIG. 2. For example, the display driver circuitry 120 may execute at least one displaying on the display panel 140 based on the first mode.

In operation 703, the processor 110 may provide, to the display driver circuitry 120, a control command (e.g., set_DSI_mode) indicating to change the first mode to the second mode while the display driver circuitry 120 is operating for the first mode. The display driver circuitry 120 may obtain, from the processor 110, the control command indicating to change the first mode to the second mode, in the first mode. For example, the control command may be provided to the display driver circuitry 120 together with at least one other control command. For example, the at least one control command may indicate a refresh rate for the second mode to be changed from the first mode. For example, the at least one control command may include a control command (e.g., set_tear_scanline) indicating scanning of the display driver circuitry 120 for the second mode. However, it is not limited thereto. For another example, the display driver circuitry 120 may identify the refresh rate for the second mode that is pre-stored for (or within) the display driver circuitry 120, based at least in part on the control command indicating changing the first mode to the second mode.

In operation 705, based on the control command obtained in operation 703, the display driver circuitry 120 may provide, to the processor 110 via the second interface 112, the third signal indicating a request of the image transmission executed based on the second mode. For example, since the third signal is provided to the processor 110 via the second interface 112 from the display driver circuitry 120 for the first mode, it may also be referred to as the first signal. For example, the third signal may be a last signal provided to the processor 110 for the first mode when the processor 110 initiates executing periodic transmissions of the pulse signal (e.g., the pulse signal 191) within a reference time from the timing at which the processor 110 obtains the third signal. For example, the third signal may cause the processor 110 to execute the periodic transmissions of the pulse signal within the reference time from the timing at which the third signal is provided to the processor 110. For example, the third signal may indicate requesting for the image transmission in accordance with the second mode, based on identifying that the number of the periodic transmissions of the pulse signal initiated within the reference time from the timing reaches a reference number. For example, the reference number may vary according to a refresh rate for the second mode.

For example, the processor 110 may obtain the third signal from the display driver circuitry 120 via the second interface 112. As a non-limiting example, the third signal may also be referred to as a TE signal or may also be referred to as a RW signal.

In operation 707, the processor 110 may execute periodic transmissions of the pulse signal (e.g., the pulse signal 191) to the display driver circuitry 120 within the reference time from the timing at which the third signal is obtained from the display driver circuitry 120.

In operation 709, the processor 110 may transmit, to the display driver circuitry 120 via the first interface 111, an image in accordance with the image transmission executed based on the second mode, in response to the number of the periodic transmissions reaching the reference number. For example, the display driver circuitry 120 may receive the image from the processor 110 via the first interface 111.

In operation 711, the display driver circuitry 120 may change the first mode to the second mode by receiving, from the processor 110 via the first interface 111, the image in accordance with the image transmission executed based on the second mode.

Operation 701 to operation 711 may be further exemplified within the description of FIG. 3.

Referring to FIG. 3, the processor 110 may provide, to the display driver circuitry 120, a third control command 373 indicating to change the first mode to the second mode, a fourth control command 374 indicating a refresh rate for the second mode to be changed from the first mode, and/or a fifth control command 375 indicating scanning of the display driver circuitry 120 for the second mode to be changed to the first mode. For example, the third control command 373, the fourth control command 374, and/or the fifth control command 375 may be provided within a front porch (or a front porch interval) of a vertical synchronization signal (e.g., the vertical synchronization signal 193). However, it is not limited thereto.

For example, the display driver circuitry 120 may provide, to the processor 110 via the second interface 112, a third signal 183, in response to the third control command 373, the fourth control command 374, and/or the fifth control command 375, as indicated by arrows 351.

For example, the processor 110 may obtain the third signal 183 from the display driver circuitry 120. For example, the processor 110 may start periodic transmissions of the pulse signal 191 within the reference time from a timing of obtaining the third signal 183, as indicated by arrows 352. For example, the processor 110 may transmit, to the display driver circuitry 120 via the first interface 111, the fourth image to be displayed on the display panel 140 for the second mode, in response to the number of the periodic transmissions of the pulse signal 191 reaching the reference number, as indicated by arrows 353. For example, the transmission of the fourth image may be executed as in a state 304.

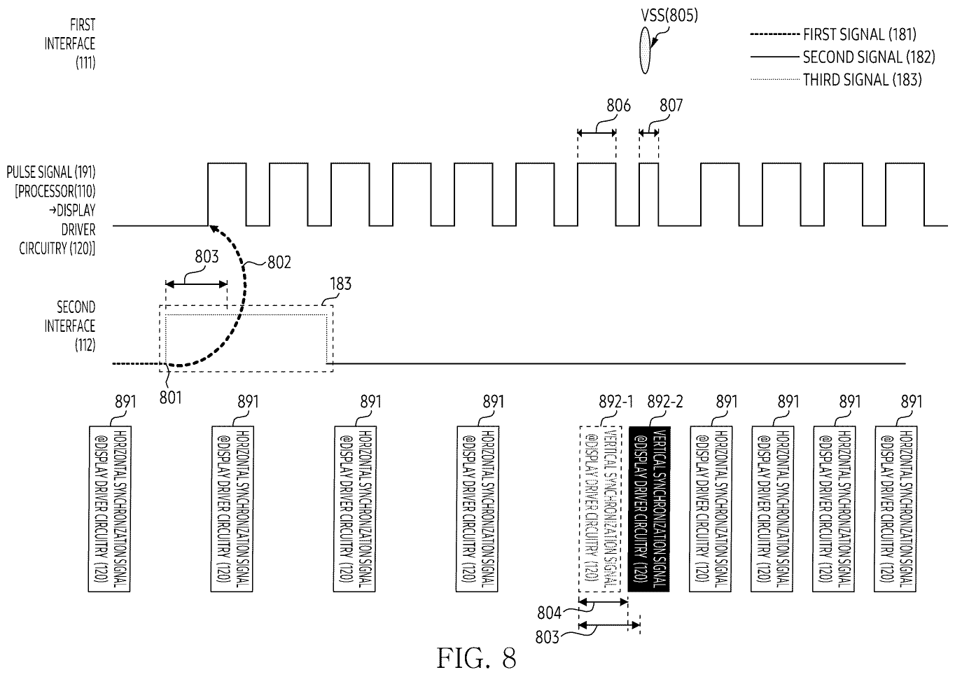

The reference time and the reference number may be further exemplified within the description of FIG. 8.

FIG. 8 illustrates an example of changing a first mode to a second mode.

Referring to FIG. 8, the display driver circuitry 120 may provide to the processor 110 via the second interface 112, a third signal 183, in response to the third control command 373, the fourth control command 374, and/or the fifth control command 375. The processor 110 may start the periodic transmissions of the pulse signal 191 within a reference time 803 from a timing 801 at which the third signal 183 is obtained from the display driver circuitry 120, as indicated by arrows 802. The periodic transmissions of the pulse signal 191 may be executed based on the refresh rate for the second mode.

For example, since a synchronization signal (e.g., horizontal synchronization signal, vertical synchronization signal, and/or light emitting synchronization signal) for the display driver circuitry 120 is not synchronized with a synchronization signal (e.g., horizontal synchronization signal, vertical synchronization signal, and/or light emitting synchronization signal) for the processor 110 in the first mode, the reference time 803 may be defined. For example, the reference time 803 may have a length during which displaying on the display panel 140 is not recognized by a user in accordance with a timing of a light emitting interval of the display driver circuitry 120 that is not synchronized with a timing at which an image for the second mode is transmitted from the processor 110. For example, when the processor 110 starts the periodic transmissions of the pulse signal 191 within the reference time 803 from the timing 801, a time 804 between a timing of a vertical synchronization signal 892-1 identified by the display driver circuitry 120 in accordance with the first mode and a timing of a vertical synchronization signal 892-2 for an image to be transmitted for the second mode in response to the number of the periodic transmissions reaching the reference number (or a timing of receiving a vertical sync start (VSS) packet 805) may be shorter than the reference time 803. As a non-limiting example, the reference time 803 may be about ⅕ of a period of a horizontal synchronization signal.

For example, the processor 110 may identify the number of the periodic transmissions that are executed within the reference time 803 from the timing 801. For example, the identification may be executed to identify a timing for the image transmission to be executed based on the second mode. For example, in response to the number of the periodic transmissions reaching the reference number, the processor 110 may change a width of the pulse signal 191 from a first width 806 to a second width 807 and transmit the VSS packet 805 to the display driver circuitry 120. For example, the processor 110 may execute the image transmission based on the second mode, in response to the number of the periodic transmissions reaching the reference number. For example, the reference number may be configured as a value for reducing lengthening of the time 804 between the timing of the vertical synchronization signal 892-1 and the timing of the vertical synchronization signal 892-2 over time. For example, when the refresh rate for the first mode is 60 (Hz) and the refresh rate for the second mode is 120 (Hz), the reference number may be about 8, as illustrated in FIG. 8. However, it is not limited thereto.

For example, a horizontal synchronization signal 891 for the display driver circuitry 120 may be synchronized with the horizontal synchronization signal for the processor 110, in response to the changing from the first width 806 to the second width 807 and/or the receiving the VSS packet 805. For example, the display driver circuitry 120 may change the first mode to the second mode, based on receiving an image from the processor 110 after the VSS packet 805.

Referring again to FIG. 3, the display driver circuitry 120 may display, on the display panel 140, the fourth image received from the processor 110 via the first interface 111 to the display driver circuitry 120 in accordance with the image transmission executed based on the second mode, as indicated by arrows 354. For example, the display driver circuitry 120 may store, in the memory 130, the fourth image received from the processor 110 via the first interface 111 to the display driver circuitry 120 in accordance with the image transmission executed based on the second mode, as indicated by arrows 355. For example, storing the fourth image may be executed based on the third control command 373, the fourth control command 374, and/or the fifth control command 375. For example, storing the fourth image may be executed to reduce occurrence of an afterimage (and/or flickering) in accordance with displaying on the display panel 140, executed for the first mode. For example, the display driver circuitry 120 may display again, on the display panel 140, the fourth image, based on scanning the fourth image in the memory 130, as indicated by arrows 356. For example, since the first mode is changed to the second mode according to receiving the fourth image as in the state 304, storing the fourth image, displaying the fourth image, and displaying again the fourth image may be executed in accordance with the refresh rate for the second mode.

Meanwhile, the display driver circuitry 120 may change the first signal 181 to the third signal 183 in response to the third control command 373, the fourth control command 374, and/or the fifth control command 375, and change the third signal 183 to the second signal 182 in response to the periodic transmissions of the pulse signal 191 (and/or reception of the fourth image) enabled according to providing the third signal 183. For example, the display driver circuitry 120 may change the state of the second signal 182 from the first state to the second state or from the second state to the first state, through methods similar to the description of the first image and the second image in FIG. 3.

As described above, the display driver circuitry 120 may change a signal provided to the processor 110 via the second interface 112 from the first signal 181 to the second signal 182 via the third signal 183 to change the first mode to the second mode. Changing the first signal 181 to the second signal 182 via the third signal 193 may be further exemplified within the description of FIG. 4.

Referring to FIG. 4, the display driver circuitry 120 may provide the first signal 181 to the processor 110, as in a state 418, after executing the displaying 417 of the image 404. For example, the display driver circuitry 120 may obtain, from the processor 110, the third control command 373, the fourth control command 374, and/or the fifth control command 375, after providing the first signal 181.

The display driver circuitry 120 may provide, to the processor 110 via the second interface 112, the third signal 183 changed from the first signal 181, in response to the third control command 373, the fourth control command 374, and/or the fifth control command 375. The third signal 183 may be provided to indicate a timing of the image transmission, like the first signal 181. For example, unlike the first signal 181, the third signal 183 may further indicate a timing for starting periodic transmissions of the pulse signal (e.g., the pulse signal 191). For example, in response to the third signal 183, the processor 110 may start the periodic transmissions (not illustrated in FIG. 4) of the pulse signal within the reference time from a timing of obtaining the third signal 183.

For example, the processor 110 may transmit, to the display driver circuitry 120 via the first interface 111, an image 405 in accordance with the image transmission executed based on the second mode, on a condition that the number of the periodic transmissions reaches the reference number. For example, a timing at which the image 405 is received may be different from a timing of the vertical synchronization signal for the display driver circuitry 120, indicated by the first signal 181. For example, the third signal 183 is common to the first signal 181 in terms of indicating a timing of the image transmission, but the third signal 183 may indicate another timing distinct from a timing indicated by the first signal 181.

Meanwhile, the display driver circuitry 120 may display the image 405 on the display panel 140 and store the image 405 in the memory 130. The display driver circuitry 120 may provide the second signal 182 changed from the third signal 183 based on a reception of the image 405 (or start of the periodic transmissions of the pulse signal).

For example, the display driver circuitry 120 may change the state of the second signal 182 from the second state to the first state, in response to completion of scanning the displaying of the image 405. The processor 110 may transmit an image 406 to the display driver circuitry 120 via the first interface 111, in response to the first state of the second signal 182. The display driver circuitry 120 may display, on the display panel 140, the image 406. As a non-limiting example, the display driver circuitry 120 may discard the image 405 stored in the memory 130, in response to receiving the image 406.

As described above, the electronic device 100 may provide the seamlessly changing from the first mode to the second mode, based at least in part on the periodic transmissions of the pulse signal that are initiated within the reference time from a timing of obtaining the third signal.

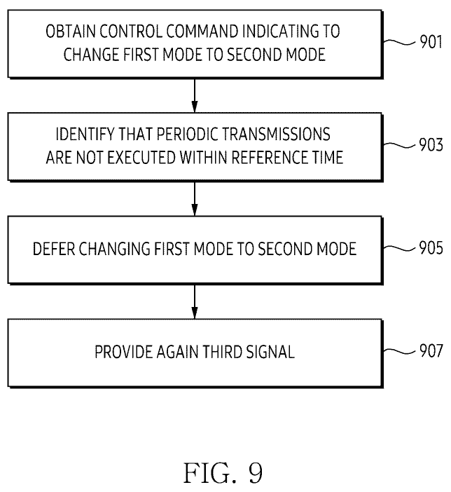

Referring back to FIG. 1, the display driver circuitry 120 may defer changing the first mode to the second mode, based on the periodic transmissions of the pulse signal that are not initiated within the reference time from the timing the timing of transmitting the third signal to the processor 110. Deferring the changing of the first mode to the second mode may be exemplified within the description of FIG. 9.

FIG. 9 illustrates an exemplary method of deferring changing from a first mode to a second mode.

Referring to FIG. 9, in operation 901, the display driver circuitry 120 may obtain, from the processor 110, a control command indicating to change the first mode to the second mode. For example, the display driver circuitry 120 may provide, to the processor 110, the third signal, in response to the control command. For example, the display driver circuitry 120 may identify whether the periodic transmissions of the pulse signal are executed within the reference time from a timing at which the third signal is provided to the processor 110. For example, operation 901 may correspond to operations 701 and 703 of FIG. 7.

In operation 903, the display driver circuitry 120 may identify that the periodic transmissions are not executed within the reference time.

In operation 905, the display driver circuitry 120 may defer changing the first mode to the second mode, based on the identification in operation 903. For example, the display driver circuitry 120 may maintain the first mode independently from the control command obtained in operation 901. For example, the display driver circuitry 120 may defer the changing from the first mode to the second mode in accordance with the control command, by maintaining the first mode.

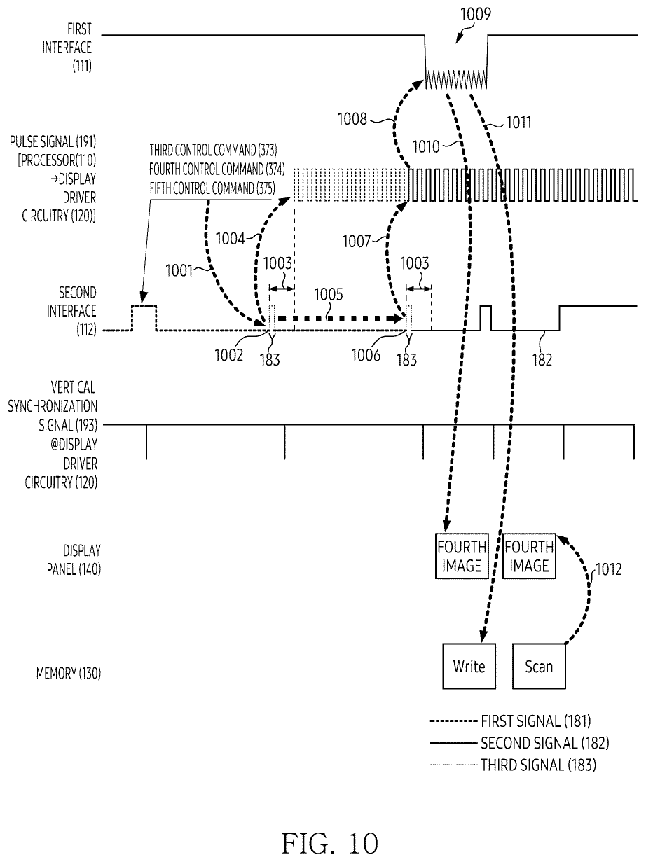

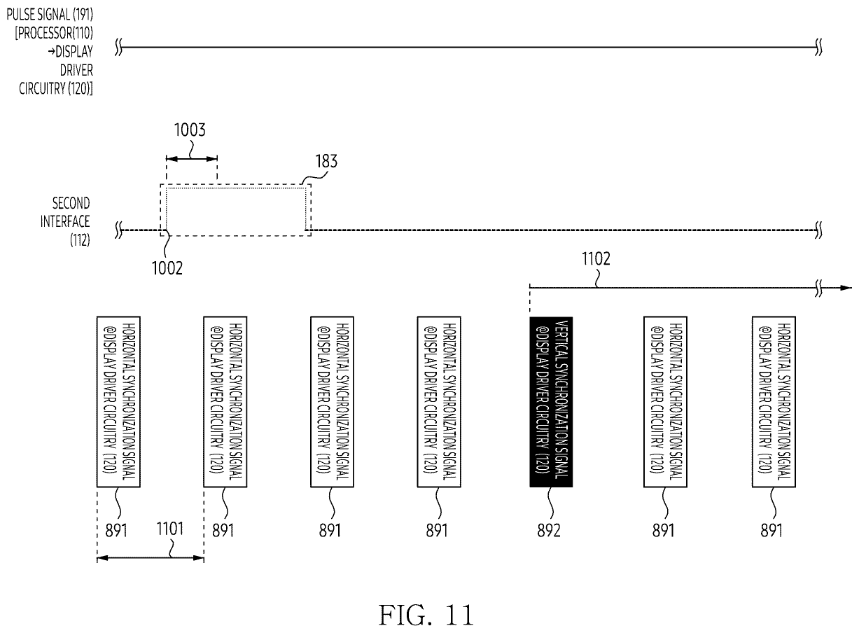

In operation 907, the display driver circuitry 120 may provide again, to the processor 110 via the second interface 112, the third signal, for the changing from the first mode to the second mode. Providing again the third signal may be exemplified within the description of FIG. 10 and the description of FIG. 11.

FIGS. 10 and 11 illustrate an example of deferring changing a first mode to a second mode.

Referring to FIG. 10, the display driver circuitry 120 may obtain, from the processor 110, a third control command 373, a fourth control command 374, and/or a fifth control command 375. The display driver circuitry 120 may provide, to the processor 110 via the second interface 112, a third signal 183, as indicated by arrows 1001. For example, the display driver circuitry 120 may identify that the periodic transmissions of the pulse signal 191 are not executed within a reference time 1003 (e.g., the reference time 803) from a timing 1002 providing the third signal 183, as indicated by arrows 1004. The display driver circuitry 120 may defer changing the first mode to the second mode, in response to the identification. For example, the display driver circuitry 120 may refrain from changing the first mode to the second mode, in response to the identification. Refraining from changing the first mode to the second mode may be exemplified within the description of FIG. 11.

Referring to FIG. 11, the display driver circuitry 120 may provide, to the processor 110 via the second interface 112, the third signal 183, at the timing 1002, in response to the third control command 373, the fourth control command 374, and/or the fifth control command 375. In response to the pulse signal 191 being disabled within the reference time 1003 from the timing 1002, the display driver circuitry 120 may refrain from changing the first mode to the second mode and maintain the first mode. For example, the display driver circuitry 120 may operate based on the refresh rate for the first mode. For example, the display driver circuitry 120 may refrain from changing the third signal 183 to the second signal 182. For example, a period 1101 of a horizontal synchronization signal 891 for the display driver circuitry 120 may be maintained as a period corresponding to the refresh rate for the first mode. For example, a period 1102 of a vertical synchronization signal 892 for the display driver circuitry 120 may be maintained as a period corresponding to the refresh rate for the first mode.

Referring again to FIG. 10, the display driver circuitry 120 may provide again, to the processor 110 via the second interface 112, the third signal 183, as indicated by arrows 1005, to change the first mode to the second mode. For example, the third signal 183 may be provided again to the processor 110 to change the first mode to the second mode.

For example, the processor 110 may execute the periodic transmissions of the pulse signal 191, as indicated by arrows 1007, within a reference time 1003 from a timing 1006 at which the third signal 183 is obtained from the display driver circuitry 120. For example, the processor 110 may transmit, to the display driver circuitry 120 via the first interface 111, the fourth image, as indicated by arrows 1008, based on the number of the periodic transmissions reaching the reference number. For example, the transmission of the fourth image may be indicated as in a state 1009.

For example, the display driver circuitry 120 may display, on the display panel 140, the fourth image received from the processor 110 to the display driver circuitry 120 via the first interface 111 in accordance with the image transmission executed based on the second mode, as indicated by arrows 1010. For example, the display driver circuitry 120 may store, in the memory 130, the fourth image received from the processor 110 to the display driver circuitry 120 via the first interface 111 in accordance with the image transmission executed based on the second mode, as indicated by arrows 1011. For example, storing the fourth image may be executed based on the third control command 373, the fourth control command 374, and/or the fifth control command 375. For example, storing the fourth image may be executed to reduce occurrence of an afterimage (and/or flickering) in accordance with displaying on the display panel 140, executed for the first mode. For example, the display driver circuitry 120 may display again, on the display panel 140, the fourth image, based on scanning the fourth image in the memory 130, as indicated by arrows 1012. For example, since the first mode is changed to the second mode according to receiving the fourth image, as in the state 1009, storing the fourth image, displaying the fourth image, and displaying again the fourth image may be executed in accordance with the refresh rate for the second mode.

Meanwhile, the display driver circuitry 120 may change the first signal 181 to the third signal 183 in response to the periodic transmissions of the pulse signal 191 (and/or reception of the fourth image) enabled by providing again the third signal 183 and change the third signal 183 to the second signal 182 in response to providing the third signal 183 to the processor 110. For example, the display driver circuitry 120 may change the state of the second signal 182 from the first state to the second state or from the second state to the first state, through methods similar to the description of the first image and the second image in FIG. 3.

As described above, the electronic device 100 may provide the seamlessly changing from the first mode to the second mode by deferring the changing from the first mode to the second mode according to providing again the third signal 183.

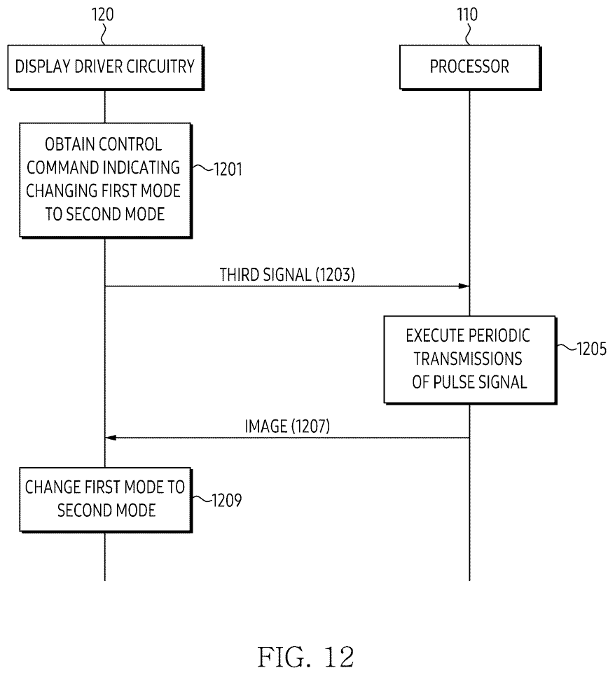

Although FIGS. 7 and 9 illustrate an example in which the first mode is changed to the second mode after the second mode being changed to the first mode, changing the first mode to the second mode may be executed independently from changing the second mode to the first mode. The execution may be exemplified within the description of FIG. 12.

FIG. 12 illustrates an exemplary method of changing a first mode to a second mode.

Referring to FIG. 12, in operation 1201, the display driver circuitry 120 may obtain, from the processor 110, a control command indicating changing the first mode to the second mode.

In operation 1203, the display driver circuitry 120 may provide, to the processor 110, the third signal indicating a request for the image transmission executed based on the second mode in response to the control command. For example, the processor 110 may obtain the third signal from the display driver circuitry 120 via the second interface 112.

In operation 1205, the processor 110 may execute periodic transmissions of the pulse signal (e.g., the pulse signal 191) to the display driver circuitry 120, in order to synchronize at least one time interval in the processor 110 used for displaying on the display panel 140 with at least one time interval in the display driver circuitry 120 used for displaying on the display panel 140, within the reference time from a timing of obtaining the third signal from the display driver circuitry 120. For example, the pulse signal may indicate a timing of a horizontal synchronization signal, a vertical synchronization signal, and/or a light emitting synchronization signal for the processor 110.

In operation 1207, the processor 110 may transmit, to the display driver circuitry 112 via the first interface 111, an image, in accordance with the image transmission executed based on the second mode, in response to the number of the periodic transmissions reaching the reference number. The display driver circuitry 120 may receive the image.

In operation 1209, the display driver circuitry 120 may change the first mode to the second mode by receiving the image. For example, the display driver circuitry 120 may change the first mode to the second mode, based on a VSS packet received from the processor 110 before the image. For example, the display driver circuitry 120 may change the first mode to the second mode based on the periodic transmissions executed in operation 1205.

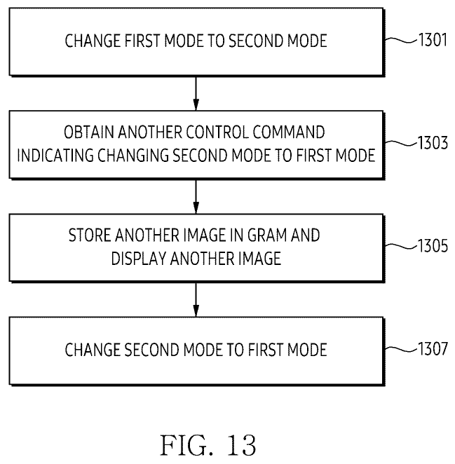

For example, the display driver circuitry 120 may execute displaying of an image on the display panel 140, within the second mode changed from the first mode. For example, the display driver circuitry 120 may obtain, from the processor 110, another control command indicating changing from the second mode to the first mode while the second mode is provided. For example, the display driver circuitry 120 may execute operations for changing the second mode to the first mode, based on the other control command. The operations may be exemplified within the description of FIG. 13.

FIG. 13 illustrates an exemplary method of changing a second mode to a first mode after changing the first mode to the second mode.

Referring to FIG. 13, in operation 1301, the display driver circuitry 120 may change the first mode to the second mode. Operation 1301 may correspond to operation 1209 of FIG. 12.

In operation 1303, the display driver circuitry 120 may obtain, from the processor 110, another control command indicating changing the second mode to the first mode, within the second mode.

In operation 1305, the display driver circuitry 120 may store, in the memory 130, another image received from the processor 110 via the first interface 111 in accordance with the image transmission executed based on the second mode, and may display, on the display panel 140, the other image received from the processor 110 via the first interface 111 in accordance with the image transmission executed based on the second mode. For example, displaying the other image and storing the other image may be executed based on the second mode.

In operation 1307, the display driver circuitry 120 may change the second mode to the first mode based on the other control command, in response to storing the other image. For example, the display driver circuitry 120 may display again, on the display panel 140, the other image in the memory 130, in accordance with the refresh rate for the first mode.

FIG. 14 is a block diagram illustrating an electronic device 1401 in a network environment 1400 according to various embodiments. Referring to FIG. 14, the electronic device 1401 in the network environment 1400 may communicate with an electronic device 1402 via a first network 1498 (e.g., a short-range wireless communication network), or at least one of an electronic device 1404 or a server 1408 via a second network 1499 (e.g., a long-range wireless communication network). According to an embodiment, the electronic device 1401 may communicate with the electronic device 1404 via the server 1408. According to an embodiment, the electronic device 1401 may include a processor 1420, memory 1430, an input module 1450, a sound output module 1455, a display module 1460, an audio module 1470, a sensor module 1476, an interface 1477, a connecting terminal 1478, a haptic module 1479, a camera module 1480, a power management module 1488, a battery 1489, a communication module 1490 comprising communication circuitry, a subscriber identification module (SIM) 1496, or an antenna module 1497. In some embodiments, at least one of the components (e.g., the connecting terminal 1478) may be omitted from the electronic device 1401, or one or more other components may be added in the electronic device 1401. In some embodiments, some of the components (e.g., the sensor module 1476, the camera module 1480, or the antenna module 1497) may be implemented as a single component (e.g., the display module 1460).

The processor 1420 may execute, for example, software (e.g., a program 1440) to control at least one other component (e.g., a hardware or software component) of the electronic device 1401 coupled with the processor 1420, and may perform various data processing or computation. According to an embodiment, as at least part of the data processing or computation, the processor 1420 may store a command or data received from another component (e.g., the sensor module 1476 or the communication module 1490) in volatile memory 1432, process the command or the data stored in the volatile memory 1432, and store resulting data in non-volatile memory 1434. According to an embodiment, the processor 1420 may include a main processor 1421 (e.g., a central processing unit (CPU) or an application processor (AP)), or an auxiliary processor 1423 (e.g., a graphics processing unit (GPU), a neural processing unit (NPU), an image signal processor (ISP), a sensor hub processor, or a communication processor (CP)) that is operable independently from, or in conjunction with, the main processor 1421. For example, when the electronic device 1401 includes the main processor 1421 and the auxiliary processor 1423, the auxiliary processor 1423 may be adapted to consume less power than the main processor 1421, or to be specific to a specified function. The auxiliary processor 1423 may be implemented as separate from, or as part of the main processor 1421.

The auxiliary processor 1423 may control at least some of functions or states related to at least one component (e.g., the display module 1460, the sensor module 1476, or the communication module 1490) among the components of the electronic device 1401, instead of the main processor 1421 while the main processor 1421 is in an inactive (e.g., sleep) state, or together with the main processor 1421 while the main processor 1421 is in an active state (e.g., executing an application). According to an embodiment, the auxiliary processor 1423 (e.g., an image signal processor or a communication processor) may be implemented as part of another component (e.g., the camera module 1480 or the communication module 1490) functionally related to the auxiliary processor 1423. According to an embodiment, the auxiliary processor 1423 (e.g., the neural processing unit) may include a hardware structure specified for artificial intelligence model processing. An artificial intelligence model may be generated by machine learning. Such learning may be performed, e.g., by the electronic device 1401 where the artificial intelligence is performed or via a separate server (e.g., the server 1408). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1430 may store various data used by at least one component (e.g., the processor 1420 or the sensor module 1476) of the electronic device 1401. The various data may include, for example, software (e.g., the program 1440) and input data or output data for a command related thereto. The memory 1430 may include the volatile memory 1432 or the non-volatile memory 1434.

The program 1440 may be stored in the memory 1430 as software, and may include, for example, an operating system (OS) 1442, middleware 1444, or an application 1446.

The input module 1450 may receive a command or data to be used by another component (e.g., the processor 1420) of the electronic device 1401, from the outside (e.g., a user) of the electronic device 1401. The input module 1450 may include, for example, a microphone, a mouse, a keyboard, a key (e.g., a button), or a digital pen (e.g., a stylus pen).

The sound output module 1455 may output sound signals to the outside of the electronic device 1401. The sound output module 1455 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1460 may visually provide information to the outside (e.g., a user) of the electronic device 1401. The display module 1460 may include, for example, a display, a hologram device, or a projector and control circuitry to control a corresponding one of the display, hologram device, and projector. According to an embodiment, the display module 1460 may include a touch sensor adapted to detect a touch, or a pressure sensor adapted to measure the intensity of force incurred by the touch.

The audio module 1470 may convert a sound into an electrical signal and vice versa. According to an embodiment, the audio module 1470 may obtain the sound via the input module 1450, or output the sound via the sound output module 1455 or a headphone of an external electronic device (e.g., an electronic device 1402) directly (e.g., wiredly) or wirelessly coupled with the electronic device 1401.

The sensor module 1476 may detect an operational state (e.g., power or temperature) of the electronic device 1401 or an environmental state (e.g., a state of a user) external to the electronic device 1401, and then generate an electrical signal or data value corresponding to the detected state. According to an embodiment, the sensor module 1476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1477 may support one or more specified protocols to be used for the electronic device 1401 to be coupled with the external electronic device (e.g., the electronic device 1402) directly (e.g., wiredly) or wirelessly. According to an embodiment, the interface 1477 may include, for example, a high definition multimedia interface (HDMI), a universal serial bus (USB) interface, a secure digital (SD) card interface, or an audio interface.

A connecting terminal 1478 may include a connector via which the electronic device 1401 may be physically connected with the external electronic device (e.g., the electronic device 1402). According to an embodiment, the connecting terminal 1478 may include, for example, an HDMI connector, a USB connector, a SD card connector, or an audio connector (e.g., a headphone connector).

The haptic module 1479 may convert an electrical signal into a mechanical stimulus (e.g., a vibration or a movement) or electrical stimulus which may be recognized by a user via his tactile sensation or kinesthetic sensation. According to an embodiment, the haptic module 1479 may include, for example, a motor, a piezoelectric element, or an electric stimulator.

The camera module 1480 may capture a still image or moving images. According to an embodiment, the camera module 1480 may include one or more lenses, image sensors, image signal processors, or flashes.

The power management module 1488 may manage power supplied to the electronic device 1401. According to an embodiment, the power management module 1488 may be implemented as at least part of, for example, a power management integrated circuit (PMIC).

The battery 1489 may supply power to at least one component of the electronic device 1401. According to an embodiment, the battery 1489 may include, for example, a primary cell which is not rechargeable, a secondary cell which is rechargeable, or a fuel cell.

The communication module 1490 may support establishing a direct (e.g., wired) communication channel or a wireless communication channel between the electronic device 1401 and the external electronic device (e.g., the electronic device 1402, the electronic device 1404, or the server 1408) and performing communication via the established communication channel. The communication module 1490 may include one or more communication processors that are operable independently from the processor 1420 (e.g., the application processor (AP)) and supports a direct (e.g., wired) communication or a wireless communication. According to an embodiment, the communication module 1490 may include a wireless communication module 1492 comprising communication circuitry (e.g., a cellular communication module, a short-range wireless communication module, or a global navigation satellite system (GNSS) communication module) or a wired communication module 1494 (e.g., a local area network (LAN) communication module or a power line communication (PLC) module). A corresponding one of these communication modules may communicate with the external electronic device via the first network 1498 (e.g., a short-range communication network, such as Bluetooth™, wireless-fidelity (Wi-Fi) direct, or infrared data association (IrDA)) or the second network 1499 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1492 may identify and authenticate the electronic device 1401 in a communication network, such as the first network 1498 or the second network 1499, using subscriber information (e.g., international mobile subscriber identity (IMSI)) stored in the subscriber identification module 1496.

The wireless communication module 1492 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1492 may support a high-frequency band (e.g., the mmWave band) to achieve, e.g., a high data transmission rate. The wireless communication module 1492 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1492 may support various requirements specified in the electronic device 1401, an external electronic device (e.g., the electronic device 1404), or a network system (e.g., the second network 1499). According to an embodiment, the wireless communication module 1492 may support a peak data rate (e.g., 20 Gbps or more) for implementing eMBB, loss coverage (e.g., 1464 dB or less) for implementing mMTC, or U-plane latency (e.g., 0.5 ms or less for each of downlink (DL) and uplink (UL), or a round trip of 14 ms or less) for implementing URLLC.

The antenna module 1497 may transmit or receive a signal or power to or from the outside (e.g., the external electronic device) of the electronic device 1401. According to an embodiment, the antenna module 1497 may include an antenna including a radiating element composed of a conductive material or a conductive pattern formed in or on a substrate (e.g., a printed circuit board (PCB)). According to an embodiment, the antenna module 1497 may include a plurality of antennas (e.g., array antennas). In such a case, at least one antenna appropriate for a communication scheme used in the communication network, such as the first network 1498 or the second network 1499, may be selected, for example, by the communication module 1490 (e.g., the wireless communication module 1492) from the plurality of antennas. The signal or the power may then be transmitted or received between the communication module 1490 and the external electronic device via the selected at least one antenna. According to an embodiment, another component (e.g., a radio frequency integrated circuit (RFIC)) other than the radiating element may be additionally formed as part of the antenna module 1497.

According to various embodiments, the antenna module 1497 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1401 and the external electronic device 1404 via the server 1408 coupled with the second network 1499. Each of the electronic devices 1402 or 1404 may be a device of a same type as, or a different type, from the electronic device 1401. According to an embodiment, all or some of operations to be executed at the electronic device 1401 may be executed at one or more of the external electronic devices 1402, 1404, or 1408. For example, if the electronic device 1401 should perform a function or a service automatically, or in response to a request from a user or another device, the electronic device 1401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1401. The electronic device 1401 may provide the outcome, with or without further processing of the outcome, as at least part of a reply to the request. To that end, a cloud computing, distributed computing, mobile edge computing (MEC), or client-server computing technology may be used, for example. The electronic device 1401 may provide ultra low-latency services using, e.g., distributed computing or mobile edge computing. In another embodiment, the external electronic device 1404 may include an internet-of-things (IoT) device. The server 1408 may be an intelligent server using machine learning and/or a neural network. According to an embodiment, the external electronic device 1404 or the server 1408 may be included in the second network 1499. The electronic device 1401 may be applied to intelligent services (e.g., smart home, smart city, smart car, or healthcare) based on 5G communication technology or IoT-related technology.

FIG. 15 is a block diagram 1500 illustrating the display module 1460 according to various embodiments. Referring to FIG. 15, the display module 1460 may include a display 1510 and a display driver integrated circuit (DDI) 1530 to control the display 1510. The DDI 1530 may include an interface module 1531, memory 1533 (e.g., buffer memory), an image processing module 1535, or a mapping module 1537. The DDI 1530 may receive image information that contains image data or an image control signal corresponding to a command to control the image data from another component of the electronic device 1401 via the interface module 1531. For example, according to an embodiment, the image information may be received from the processor 1420 (e.g., the main processor 1421 (e.g., an application processor)) or the auxiliary processor 1423 (e.g., a graphics processing unit) operated independently from the function of the main processor 1421. The DDI 1530 may communicate, for example, with touch circuitry 1550 or the sensor module 1476 via the interface module 1531. The DDI 1530 may also store at least part of the received image information in the memory 1533, for example, on a frame by frame basis. The image processing module 1535 may perform pre-processing or post-processing (e.g., adjustment of resolution, brightness, or size) with respect to at least part of the image data. According to an embodiment, the pre-processing or post-processing may be performed, for example, based at least in part on one or more characteristics of the image data or one or more characteristics of the display 1510. The mapping module 1537 may generate a voltage value or a current value corresponding to the image data pre-processed or post-processed by the image processing module 1535. According to an embodiment, the generating of the voltage value or current value may be performed, for example, based at least in part on one or more attributes of the pixels (e.g., an array, such as an RGB stripe or a pentile structure, of the pixels, or the size of each subpixel). At least some pixels of the display 1510 may be driven, for example, based at least in part on the voltage value or the current value such that visual information (e.g., a text, an image, or an icon) corresponding to the image data may be displayed via the display 1510.

According to an embodiment, the display module 1460 may further include the touch circuitry 1550. The touch circuitry 1550 may include a touch sensor 1551 and a touch sensor IC 1553 to control the touch sensor 1551. The touch sensor IC 1553 may control the touch sensor 1551 to sense a touch input or a hovering input with respect to a certain position on the display 1510. To achieve this, for example, the touch sensor 1551 may detect (e.g., measure) a change in a signal (e.g., a voltage, a quantity of light, a resistance, or a quantity of one or more electric charges) corresponding to the certain position on the display 1510. The touch circuitry 1550 may provide input information (e.g., a position, an area, a pressure, or a time) indicative of the touch input or the hovering input detected via the touch sensor 1551 to the processor 1420. According to an embodiment, at least part (e.g., the touch sensor IC 1553) of the touch circuitry 1550 may be formed as part of the display 1510 or the DDI 1530, or as part of another component (e.g., the auxiliary processor 1423) disposed outside the display module 1460.

According to an embodiment, the display module 1460 may further include at least one sensor (e.g., a fingerprint sensor, an iris sensor, a pressure sensor, or an illuminance sensor) of the sensor module 1476 or a control circuit for the at least one sensor. In such a case, the at least one sensor or the control circuit for the at least one sensor may be embedded in one portion of a component (e.g., the display 1510, the DDI 1530, or the touch circuitry 1550)) of the display module 1460. For example, when the sensor module 1476 embedded in the display module 1460 includes a biometric sensor (e.g., a fingerprint sensor), the biometric sensor may obtain biometric information (e.g., a fingerprint image) corresponding to a touch input received via a portion of the display 1510. As another example, when the sensor module 1476 embedded in the display module 1460 includes a pressure sensor, the pressure sensor may obtain pressure information corresponding to a touch input received via a partial or whole area of the display 1510. According to an embodiment, the touch sensor 1551 or the sensor module 1476 may be disposed between pixels in a pixel layer of the display 1510, or over or under the pixel layer.

As described above, according to an embodiment, an electronic device 100 may comprise a processor 110, a display 115 including a display panel 140 and display driver circuitry 120 that includes a graphic random access memory (GRAM) 130, and an interface connecting the processor 110 to the display driver circuitry 120. According to an embodiment, the display driver circuitry 120 may be configured to obtain, from the processor 110, a control command indicating to change a second mode executing an image transmission from the processor 110 to the display driver circuitry 120 based on a timing identified by the processor 110 to a first mode executing the image transmission based on a timing identified by the display driver circuitry 120. According to an embodiment, the display driver circuitry 120 may be configured to store an image received via the interface from the processor 110 in accordance with the image transmission executed based on the second mode, in the GRAM 130 and display, on the display panel 140, the image received via the interface from the processor 110 in accordance with the image transmission executed based on the second mode. According to an embodiment, the display driver circuitry 120 may be configured to, in response to storing the image, change, based on the control command, the second mode to the first mode. “Based on” as used herein covers based at least on.

According to an embodiment, the display driver circuitry 120 may be configured to, based on a refresh rate for the second mode, display, on the display panel 140, the image.

According to an embodiment, the display driver circuitry 120 may be configured to, in response to the changing from the second mode to the first mode, display again, on the display panel 140, the image by scanning the image in the GRAM 130 based on a refresh rate for the first mode.

According to an embodiment, the display driver circuitry 120 may be configured to obtain, from the processor 110, another control command indicating the refresh rate for the first mode together with the control command.

According to an embodiment, the display driver circuitry 120 may be configured to identify the refresh rate for the first mode that is indicated by another control command obtained from the processor 110 with the control command or is pre-stored for the display driver circuitry 120.

According to an embodiment, the display driver circuitry 120 may be configured to, in response to the changing from the second mode to the first mode, refrain from processing another image received via the interface from the processor 110 in accordance with the image transmission executed based on the second mode in at least a portion of a time interval displaying again the image on the display panel 140.

According to an embodiment, the display driver circuitry 120 may be configured to, in response to the changing from the second mode to the first mode, provide, based on the refresh rate for the first mode, to the processor 110, a signal indicating a timing of the image transmission to be executed based on the first mode.

According to an embodiment, the processor 110 may be configured to, in the second mode, execute periodic transmissions of a pulse signal to the display driver circuitry 120 to synchronize at least one time interval in the display driver circuitry 120 used for a displaying on the display panel 140 with at least one time interval in the processor 110 used for the displaying on the display panel 140. According to an embodiment, the processor 110 may be configured to, after providing, to the display driver circuitry 120, the control command, cease the periodic transmissions.

According to an embodiment, the processor 110 may be configured to, before changing a mode of the display driver circuitry 120 from the second mode to the first mode, cease the periodic transmissions.

According to an embodiment, the electronic device 100 may comprise another interface connecting the processor 110 to the display driver circuitry 120. According to an embodiment, the display driver circuitry 120 may be configured to, based on the control command, change a signal provided to the processor 110 via the other interface from a second signal indicating whether enabling the image transmission to be executed based on the second mode to a first signal indicating a timing of the image transmission to be executed based on the first mode.

According to an embodiment, the display driver circuitry 120 may be configured to, in the first mode, obtain, from the processor 110, another control command indicating to change the first mode to the second mode. According to an embodiment, the display driver circuitry 120 may be configured to, in response to the other control command, provide, to the processor 110, a signal indicating a request of the image transmission executed based on the second mode. According to an embodiment, the processor 110 may be configured to, within a reference time being from a timing obtaining the signal from the display driver circuitry 120, execute periodic transmissions of a pulse signal to the display driver circuitry 120 to synchronize at least one time interval in the display driver circuitry 120 used for a displaying on the display panel 140 with at least one time interval in the processor 110 used for the displaying on the display panel 140. According to an embodiment, the processor 110 may be configured to, in response to the number of the periodic transmissions reaching a reference number, transmit, via the interface, to the display driver circuitry 120, another image in accordance with the image transmission executed based on the second mode.

According to an embodiment, the display driver circuitry 120 may be configured to, change the first mode to the second mode by receiving, via the interface, from the processor 110, the other image in accordance with the image transmission executed based on the second mode.

According to an embodiment, the display driver circuitry 120 may be configured to, in response to identifying that the periodic transmissions are not executed within the reference time being from the timing obtaining the signal from the display driver circuitry 120, defer changing the first mode to the second mode. According to an embodiment, the display driver circuitry 120 may be configured to provide again, to the processor 110, the signal based on a refresh rate for the first mode. According to an embodiment, the processor 110 may be configured to, within the reference time from a timing obtaining again the signal from the display driver circuitry 120, execute the periodic transmissions. According to an embodiment, the processor 110 may be configured to, in response to the number of the periodic transmissions reaching the reference number, transmit, via the interface, to the display driver circuitry 120, the other image in accordance with the image transmission executed based on the second mode.

As described above, according to an embodiment, an electronic device 100 may comprise a processor 110, a display 115 including a display panel 140 and display driver circuitry 120 that includes a graphic random access memory (GRAM) 130, and an interface connecting the processor 110 to the display driver circuitry 120. According to an embodiment, the display driver circuitry 120 may be configured to obtain, from the processor 110, a control command indicating to change a first mode executing the image transmission based on a timing identified by the display driver circuitry 120 to a second mode executing an image transmission from the processor 110 to the display driver circuitry 120 based on a timing identified by the processor 110. According to an embodiment, the display driver circuitry 120 may be configured to provide, to the processor 110, a signal indicating a request for the image transmission executed based on the second mode in response to the control command. According to an embodiment, the processor 110 may be configured to, within a reference time from a timing of obtaining the signal from the display driver circuitry 120, execute periodic transmissions of a pulse signal to the display driver circuitry 120, to synchronize at least one time interval within the processor 110 used for displaying on the display panel 140 with at least one time interval within the display driver circuitry 120 used for displaying on the display panel 140. According to an embodiment, the processor 110 may be configured to transmit, to the display driver circuitry 120 via the interface, an image in accordance with the image transmission executed based on the second mode, in response to the number of the periodic transmissions reaching a reference number.

According to an embodiment, the electronic device 100 may include another interface connecting the display driver circuitry 120 and the processor 110. According to an embodiment, the display driver circuitry 120 may be configured to, in response to the image, change a signal provided to the processor 110 via the other interface from a first signal indicating a timing of the image transmission to be executed based on the first mode to a second signal indicating whether enabling the image transmission to be executed based on the second mode.

According to an embodiment, the second signal may be in a first state indicating to enable the image transmission to be executed based on the second mode or a second state indicating to disable the image transmission to be executed based on the second mode. According to an embodiment, the display driver circuitry 120 may be configured to display, on the display panel 140, the image, by scanning the image received via the interface from the processor 110 in accordance with the image transmission executed based on the second mode. According to an embodiment, the display driver circuitry 120 may be configured to change a state of the second signal from the second state to the first state, in response to completion of the scanning of the image.

According to an embodiment, the display driver circuitry 120 may be configured to change the first mode to the second mode by receiving the image from the processor 110 via the interface.

According to an embodiment, the display driver circuitry 120 may be configured to defer changing the first mode to the second mode in response to identifying that the periodic transmissions are not executed within the reference time from the timing obtained from the display driver circuitry 120. According to an embodiment, the display driver circuitry 120 may be configured to provide again, to the processor 110, the signal, based on a refresh rate for the first mode. According to an embodiment, the processor 110 may be configured to execute the periodic transmissions, within the reference time from a timing of obtaining again the signal from the display driver circuitry 120. According to an embodiment, the processor 110 may be configured to, in response to the number of the periodic transmissions reaching the reference number, transmit, to the display driver circuitry 120 via the interface, the other image, in accordance with the image transmission executed based on the second mode.

According to an embodiment, the reference number may vary according to the refresh rate for the second mode.

According to an embodiment, the display driver circuitry 120 may be configured to receive, from the processor 110, another control command indicating a refresh rate for the second mode together with the control command.

According to an embodiment, the display driver circuitry 120 may be configured to identify a refresh rate for the second mode, which is indicated by another control command obtained with the control command or is pre-stored for the display driver circuitry 120.

According to an embodiment, the display driver circuitry 120 may be configured to obtain, from the processor 110, another control command indicating to change the second mode to the first mode, within the second mode. According to an embodiment, the display driver circuitry 120 may be configured to store, in the GRAM 130, another image received via the interface from the processor 110 in accordance with the image transmission executed based on the second mode and display, on the display panel 140, the other image received via the interface from the processor 110 in accordance with the image transmission executed based on the second mode. According to an embodiment, the display driver circuitry 120 may be configured to change the second mode to the first mode based on the other control command, in response to storing the other image.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element. Thus, for example, “connected” and “connecting” as used herein covers both direct and indirect connections.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC). Thus, each “module” herein may comprise circuitry.

Various embodiments as set forth herein may be implemented as software (e.g., the program 1440) including one or more instructions that are stored in a storage medium (e.g., internal memory 1436 or external memory 1438) that is readable by a machine (e.g., the electronic device 1401). For example, a processor (e.g., the processor 1420) of the machine (e.g., the electronic device 1401) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
at least one processor comprising processing circuitry;
a display including a display panel and display driver circuitry that includes a graphic random access memory (GRAM); and
an interface, comprising circuitry, connecting the at least one processor to the display driver circuitry,
wherein the display driver circuitry is configured to:
obtain, from the at least one processor, a control command indicating to change a second mode executing an image transmission from the at least one processor to the display driver circuitry based on a timing identified by the at least one processor to a first mode executing the image transmission based on a timing identified by the display driver circuitry;
store an image received via the interface from the at least one processor in accordance with the image transmission executed based on the second mode, in the GRAM;
display, on the display panel, the image received via the interface from the at least one processor in accordance with the image transmission executed based on the second mode; and
in response to storing the image, change, based on the control command, the second mode to the first mode.

2. The electronic device of claim 1, wherein the display driver circuitry is configured to:
based on a refresh rate for the second mode, display, on the display panel, the image.

3. The electronic device of claim 1, wherein the display driver circuitry is further configured to:
in response to the changing from the second mode to the first mode, display again, on the display panel, the image by scanning the image in the GRAM based on a refresh rate for the first mode.

4. The electronic device of claim 3, wherein the display driver circuitry is further configured to:
identify the refresh rate for the first mode that is indicated by another control command obtained from the at least one processor with the control command and/or that is pre-stored.

5. The electronic device of claim 3, wherein the display driver circuitry is further configured to:
in response to the changing from the second mode to the first mode, refrain from processing another image received via the interface from the at least one processor in accordance with the image transmission executed based on the second mode in at least a portion of a time interval displaying again the image on the display panel.

6. The electronic device of claim 3, wherein the display driver circuitry is further configured to:
in response to the changing from the second mode to the first mode, provide, based on the refresh rate for the first mode, to the at least one processor, a signal indicating a timing of the image transmission to be executed based on the first mode.

7. The electronic device of claim 1, further comprising:
memory comprising one or more storage media storing instructions to, when executed by the at least one processor individually or collectively, cause the electronic device to:
in the second mode, execute periodic transmissions of a pulse signal to the display driver circuitry to synchronize at least one time interval in the display driver circuitry used for a displaying on the display panel with at least one time interval in the at least one processor used for the displaying on the display panel; and
after providing, to the display driver circuitry, the control command, cease the periodic transmissions.

8. The electronic device of claim 7, wherein the instructions, when executed by the at least one processor individually or collectively, cause the electronic device to:
before changing a mode of the display driver circuitry from the second mode to the first mode, cease the periodic transmissions.

9. The electronic device of claim 1, further comprising:
another interface, comprising circuitry, connecting the at least one processor to the display driver circuitry,
wherein the display driver circuitry is further configured to:
based on the control command, change a signal provided to the at least one processor via the another interface from a second signal indicating whether enabling the image transmission to be executed based on the second mode to a first signal indicating a timing of the image transmission to be executed based on the first mode.

10. The electronic device of claim 1, further comprising:
memory comprising one or more storage media storing instructions,
wherein the display driver circuitry is further configured to:
in the first mode, obtain, from the at least one processor, another control command indicating to change the first mode to the second mode; and
in response to the another control command, provide, to the at least one processor, a signal indicating a request of the image transmission executed based on the second mode, and
wherein the instructions, when executed by the at least one processor individually or collectively, cause the electronic device to:
within a reference time being from a timing obtaining the signal from the display driver circuitry, execute periodic transmissions of a pulse signal to the display driver circuitry to synchronize at least one time interval in the display driver circuitry used for a displaying on the display panel with at least one time interval in the at least one processor used for the displaying on the display panel; and
in response to the number of the periodic transmissions reaching a reference number, transmit, via the interface, to the display driver circuitry, another image in accordance with the image transmission executed based on the second mode.

11. The electronic device of claim 10, wherein the display driver circuitry is further configured to:
change the first mode to the second mode at least by receiving, via the interface, from the at least one processor, the other image in accordance with the image transmission executed based on the second mode.

12. The electronic device of claim 11, wherein the display driver circuitry is further configured to:
in response to identifying that the periodic transmissions are not executed within the reference time being from the timing obtaining the signal from the display driver circuitry, defer changing the first mode to the second mode; and
provide again, to the at least one processor, the signal based on a refresh rate for the first mode, and
wherein the instructions, when executed by the at least one processor individually or collectively, cause the electronic device to:
within the reference time from a timing obtaining again the signal from the display driver circuitry, execute the periodic transmissions; and
in response to the number of the periodic transmissions reaching the reference number, transmit, via the interface, to the display driver circuitry, the other image in accordance with the image transmission executed based on the second mode.

13. An electronic device comprising:
at least one processor comprising processing circuitry;
memory, comprising one or more storage media, storing instructions;
a display including:
display driver circuitry including a graphic random access memory (GRAM), and
a display panel; and
an interface, comprising circuitry, connecting the at least one processor to the display driver circuitry,
wherein the display driver circuitry is configured to:
obtain, from the at least one processor, a control command indicating to change a first mode to a second mode, wherein the first mode executes an image transmission from the at least one processor to the display driver circuitry based on a timing identified by the display driver circuitry, and wherein the second mode executes the image transmission based on a timing identified by the at least one processor;
in response to the control command, provide, to the at least one processor, a signal indicating a request for the image transmission executed based on the second mode, and
wherein the instructions, when executed by the at least one processor individually or collectively, cause the electronic device to:
within a reference time from a timing of obtaining the signal from the display driver circuitry, execute periodic transmissions of a pulse signal to the display driver circuitry, to synchronize at least one time interval within the at least one processor to be used for displaying on the display panel with at least one time interval within the display driver circuitry; and
in response to the number of the periodic transmissions reaching a reference number, transmit, to the display driver circuitry via the interface, an image in accordance with the image transmission executed based on the second mode.

14. The electronic device of claim 13, further comprising:
another interface connecting the at least one processor to the display driver circuitry,
wherein the display driver circuitry is further configured to:
in response to the image, change a signal provided to the at least one processor via the another interface from a first signal indicating a timing of the image transmission to be executed based on the first mode to a second signal indicating whether enabling the image transmission to be executed based on the second mode.

15. The electronic device of claim 14, wherein the second signal is in a first state indicating to enable the image transmission to be executed based on the second mode or a second state indicating to disable the image transmission to be executed based on the second mode, and
wherein the display driver circuitry is configured to:
display, on the display panel, the image, at least by scanning the image received via the interface from the at least one processor in accordance with the image transmission executed based on the second mode; and
in response to completion of the scanning of the image, change a state of the second signal from the second state to the first state.

16. The electronic device of claim 13, wherein the display driver circuitry is configured to change the first mode to the second mode at least by receiving the image from the at least one processor via the interface.

17. The electronic device of claim 16, wherein the display driver circuitry is configured to:
in response to identifying that the periodic transmissions are not executed within the reference time from the timing obtained from the display driver circuitry, defer changing the first mode to the second mode; and
based on a refresh rate for the first mode, provide again, to the at least one processor, the signal, and
wherein the instructions, when executed by the at least one processor individually or collectively, cause the electronic device to:
execute the periodic transmissions, within the reference time from a timing of obtaining again the signal from the display driver circuitry; and
in response to the number of the periodic transmissions reaching the reference number, transmit, to the display driver circuitry via the interface, the other image, in accordance with the image transmission executed based on the second mode.

18. The electronic device of claim 13, wherein the reference number varies according to the refresh rate for the second mode.

19. The electronic device of claim 13, wherein the display driver circuitry is configured to receive, from the at least one processor, another control command indicating a refresh rate for the second mode together with the control command.

20. The electronic device of claim 13, wherein the display driver circuitry is configured to:
obtain, from the at least one processor, another control command indicating to change the second mode to the first mode, within the second mode;
store, in the GRAM, another image received via the interface from the at least one processor in accordance with the image transmission executed based on the second mode;
display, on the display panel, the other image received via the interface from the at least one processor in accordance with the image transmission executed based on the second mode; and
in response to storing the other image, change the second mode to the first mode based on the other control command.
